(19) United States
(12) Patent Application Publication
(10) Pub. No.: US 2015/0165628 A1
(43) Pub. Date: Jun. 18, 2015

(54) MOUNTING POSITION VARIATION APPARATUS FOR ASSEMBLY DEVICE IN VEHICLE ASSEMBLY LINE

(71) Applicant: HYUNDAI MOTOR COMPANY, Seoul (KR)

(72) Inventors: So Young Lee, Uiwang (KR); Sung Phil Ryu, Seoul (KR)

(21) Appl. No.: 14/491,047

(22) Filed: Sep. 19, 2014

(30) Foreign Application Priority Data
Dec. 17, 2013 (KR) 10-2013-0157604

(51) Int. Cl. B25J 17/02; B25J 9/16; B23K 11/31

(52) U.S. Cl. CPC B25J 17/0241; B23K 11/318; B25J 9/1687; Y10S 901/29

(57) ABSTRACT

A mounting position variation apparatus for an assembly device is an apparatus used in a vehicle assembly line for changing the mounting position and angle of an assembly device on a carrying unit that can move is several axial directions, and includes i) a first mounting part mounted on the carrying unit, ii) a second mounting part rotatably disposed on the first mounting part and mounted on the assembly device, and iii) a driving unit mounted on the first mounting part to rotate the second mounting part at predetermined angles, and connected with the second mounting part.

### CROSS-REFERENCE TO RELATED APPLICATION

This application claims under 35 U.S.C. §119(a) priority to and the benefit of Korean Patent Application No. 10-2013-0157604 filed in the Korean Intellectual Property Office on Dec. 17, 2013, the entire contents of which are incorporated herein by reference.

### BACKGROUND

(a) Field of the Invention

The present invention relates to a mounting position variation apparatus for an assembly device for use in a vehicle assembly line, more particularly, to a mounting position variation apparatus for an assembly device which can change a mounting position and an angle of a mounting device such as a spot welding gun arranged on a carrying unit.

(b) Description of the Related Art

In general, parts such as panels are assembled to vehicle bodies by bolting, riveting, and welding etc. in vehicle body assembly lines. A bolt runner, a nut runner, a riveting machine, and a spot welding gut can be exemplified as the assembly devices for combining those parts to vehicle bodies.

The assembly devices are mounted on carrying units such as a gantry robot or an articulated robot through a mount and assemble parts to vehicle bodies while moving along predetermined paths by means of the carrying units.

When parts are welded to vehicle bodies at the positions of various welding points or parts are assembled to new vehicles or different kinds of vehicle bodies, it is impossible to use the assembly devices on the existing carrying units due to interference with the vehicle bodies, and there are many variables such as path interference of the transferring apparatuses moving to assemble parts to vehicle bodies.

In this case, it is required to change the position or angle of the mounts of the carrying units where assembly devices are mounted. However, changing the position or angle of the mounts for assembly devices to cope with the positions of various welding points, new vehicles, or the vehicle bodies of different types of vehicles makes it difficult to cope with the vehicle bodies of the existing types of vehicles, such that it is required to additionally manufacture a new assembly device and carrying unit.

Accordingly, the investment cost may be increased in the related art because it is required to manufacture a new assembly device and carrying unit for changing the position and angle of the mount for an assembly device in order to cope with the positions of various welding points, new vehicles, or the vehicle bodies of different types of vehicles.

The Description of the Related Art is made to help understanding the background of the present invention and may include matters out of the related art known to those skilled in the art.

The above information disclosed in this Background section is only for enhancement of understanding of the background of the invention and therefore it may contain information that does not form the prior art that is already known in this country to a person of ordinary skill in the art.

### SUMMARY

The present invention discloses a mounting position variation apparatus for an assembly device having advantageous of being able to automatically change the mounting position and angle of an assembly device on a carrying unit for assembly at the positions of various welding points, new vehicles, or different kinds of vehicle bodies.

An exemplary embodiment of the present invention provides a mounting position variation apparatus for an assembly device which is an apparatus for changing a mounting position and an angle of the assembly device on a carrying unit that can move in several axial directions, and may include i) a first mounting part mounted on the carrying unit, ii) a second mounting part rotatably disposed on the first mounting part and mounted on the assembly device, and iii) a driving unit mounted on the first mounting part and connected with the second mounting part to rotate the second mounting part at predetermined angles.

In the mounting position variation apparatus for an assembly device according to an exemplary embodiment of the present invention, the second mounting part may be connected with the first mounting part through a bearing.

In the mounting position variation apparatus for an assembly device according to an exemplary embodiment of the present invention, the second mounting part may have a gear connecting portion protruding toward the first mounting part.

In the mounting position variation apparatus for an assembly device according to an exemplary embodiment of the present invention, the driving unit may change the mounting position of the assembly device from a top mounting position to a side mounting position by rotating the second mounting part.

In the mounting position variation apparatus for an assembly device according to an exemplary embodiment of the present invention, the driving unit may include a servo motor fixed to the first mounting part and a driving gear connected with the driving shaft of the servo motor and with the gear connecting portion.

In the mounting position variation apparatus for an assembly device according to an exemplary embodiment of the present invention, the driving gear may be a worm gear.

In the mounting position variation apparatus for an assembly device according to an exemplary embodiment of the present invention, a worm wheel may be provided with the gear connecting portion in mesh with the worm gear.

In the mounting position variation apparatus for an assembly device according to an exemplary embodiment of the present invention, the first and second mounting parts each may have a triangular cross-section.

In the mounting position variation apparatus for an assembly device according to an exemplary embodiment of the present invention, the first and second mounting parts each may have two inclined planes and a bottom.

In the mounting position variation apparatus for an assembly device according to an exemplary embodiment of the present invention, the bottoms of the first and second mounting parts may be connected with each other through a bearing.

In the mounting position variation apparatus for an assembly device according to an exemplary embodiment of the present invention, any one of the inclined planes of the first mounting part may be the mounting side connected with the carrying unit.

In the mounting position variation apparatus for an assembly device according to an exemplary embodiment of the present invention, any one of the inclined planes of the second mounting part may be the mounting side connected with the assembly device.

In the mounting position variation apparatus for an assembly device according to an exemplary embodiment of the present invention, the second mounting part may rotate at 180 degrees with respect to the first mounting part.

In the mounting position variation apparatus for an assembly device according to an exemplary embodiment of the present invention, the mounting side of the first mounting part and the mounting side of the second mounting part may be positioned to be perpendicular to each other.

Another exemplary embodiment of the present invention provides a mounting position variation apparatus for an assembly device for changing a mounting position and an angle of a spot welding gun on an arm of a welding robot that can move in several axial directions, and may include i) a first mounting part mounted on the welding robot, ii) a second mounting pat rotatably disposed on the first mounting part and mounted on the spot welding gun, and iii) a driving unit mounted on the first mounting part and connected with the second mounting part to rotate the second mounting part at predetermined angles.

In the mounting position variation apparatus for an assembly device according to another exemplary embodiment of the present invention, the driving unit may change the mounting position of the spot welding gun from a top mounting position to a side mounting position by rotating the second mounting part.

According to the exemplary embodiments of the present invention, it is possible to automatically change the mounting position and angle of an assembly device, it is possible to actively cope with assembly at the positions of various welding points and for new vehicles and different kinds of vehicle bodies even without manufacturing new assembly device and carrying unit.

Therefore, an exemplary embodiment of the present invention, it is possible to reduce the initial investment cost for manufacture a new assembly device and a new transfer apparatus to change the mounting position and angle of the assembly device in accordance with the positions of various welding points, new vehicles, or different kinds of vehicle bodies.

### BRIEF DESCRIPTION OF THE DRAWINGS

The drawings are provided for reference in describing exemplary embodiments of the present invention and the spirit of the present invention should not be construed only by the accompanying drawings.

FIG. 1 is a perspective view of a mounting position variation apparatus for an assembly device according to an exemplary embodiment of the present invention.

FIG. 2 is cross-sectional view showing the mounting position variation apparatus for the assembly device of FIG. 1.

FIG. 3 is a view illustrating operation of the mounting position variation apparatus for the assembly device according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The unrelated parts to the description of the exemplary embodiments are not shown to make the description clear and like reference numerals designate like element throughout the specification.

Further, the sizes and thicknesses of the configurations shown in the drawings are provided selectively for the convenience of description, so that the present invention is not limited to those shown in the drawings and the thicknesses are exaggerated to make some parts and regions clear.

Discriminating the names of components with the first, and the second, etc. in the following description is for discriminating them for the same relationship of the components and the components are not limited to the order in the following description.

Further, the terms, “ . . . unit”, “ . . . mechanism”, “ . . . portion”, “ ... member” etc. used herein mean the unit of inclusive components performing at least one or more functions or operations.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

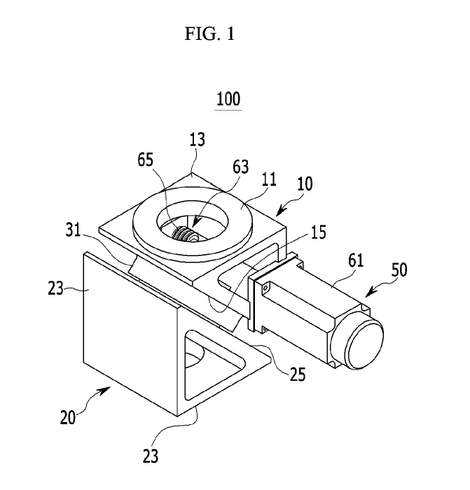

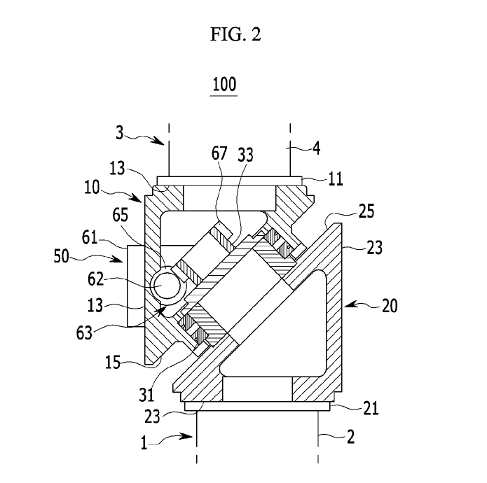

FIG. 1 is a perspective view of a mounting position variation apparatus for an assembly device according to an exemplary embodiment of the present invention and FIG. 2 is cross-sectional view showing the mounting position variation apparatus for the assembly device of FIG. 1.

Referring to FIGS. 1 and 2, a mounting position variation apparatus 100 for an assembly device according to an exemplary embodiment of the present invention can be used in a part assembly process for assembling parts, which are objects to be assembled, to a mother part, in particular, in a vehicle assembly line.

For example, the mounting position variation apparatus 100 for an assembly device according to an exemplary embodiment of the present invention is available for a vehicle body assembly process of assembling parts, which are objects to be assembled such as panels, to a vehicle body in the vehicle assembly line.

The mounting position variation apparatus 100 for an assembly device according to an exemplary embodiment of the present invention is a mounting apparatus as a unit for mounting an assembly device (or tool) 1, which can assemble parts to a vehicle body, on a transferring apparatus 3 that can reach a vehicle body.

Further, the mounting position variation apparatus 100 for an assembly device according to an exemplary embodiment of the present invention changes a mounting position and an angle of the assembly device 1 on the transferring apparatus 3.

The transferring apparatus 3 used in an exemplary embodiment of the present invention may include a multi-axis/articulated carrying unit such as a gantry robot or an articulated robot that can move a transfer target in several axial directions.

The assembly device 1 used in an exemplary embodiment of the present invention may include a bolt runner, a nut runner, a riveting machine, and a spot welding gun for assembling parts to a vehicle body.

However, the scope of the present invention should not be construed as being limited thereto and the spirit of the present invention can be applied to various carrying units and assembly devices that have been known in the art.

In an exemplary embodiment of the present invention, a multi-axis/articulated robot 4 (hereafter, referred to as a “welding robot” for convenience of description) is included as the carrying unit 3, and a spot welding gun 2 may be included as the assembly device 1.

The configuration of the mounting position variation apparatus 100 for an assembly device according to an exemplary embodiment of the present invention is described hereafter with the welding robot 4 and the spot welding gun 2 as an example.

The mounting position variation apparatus 100 can automatically change the mounting position and angle of the spot welding gun 2 on the welding robot 4, for assembly at the positions of various welding points and for new vehicles and different kinds of vehicle bodies.

To this end, the mounting position variation apparatus 100 includes a first mounting part 10, a second mounting part 20, and a driving unit 50.

The first mounting part 10 is mounted on the carrying unit 3, for example, at the arm end of the welding robot 4. Preferably the first mounting part 10 is mounted at the arm end of the welding robot 4 by means of a first mounting bracket 11. The first mounting bracket 11 may be mounted at the arm end of the welding robot 4 by means of a tool changer (not shown).

The first mounting part 10 preferably has a hollow triangular cross-section and it has two inclined planes 13 and a bottom 15 when it is arranged vertically. Any one of the inclined planes 13 is used as the mounting side where the first mounting bracket 11 is mounted, as described above.

The second mounting part 20 is mounted on the assembly device 1, for example, on a mounting flange (not shown) of the spot welding gun 2. The second mounting part 20 is mounted on the mounting flange of the spot welding gun 2 through a second mounting bracket 21.

With the spot welding gun 2 arranged vertically, the mounting flange may be formed at the top of the spot welding gun 2 or at a side of the spot welding gun 2.

The second mounting part 20 preferably has a hollow triangular cross-section and it has two inclined planes 23 and a bottom 25 when it is arranged vertically. Any one of the inclined planes 23 is used as the mounting side where the second mounting bracket 21 is mounted, as described above.

When the mounting flange is formed at the top of the spot welding gun 2, the mounting side of the second mounting part 20 may be the bottom, and when the mounting flange is formed at a side of the spot welding gun 2, the mounting side of the second mounting part 20 may be a side.

The second mounting part 20 may be rotatably disposed on the first mounting part 10. The second mounting part 20 preferably is rotatably disposed on the first mounting part 10 by means of a bearing 31. In particular, the bottom 15 of the first mounting part 10 and the bottom 25 of the second mounting part 20 can be connected through the bearing 31.

In this configuration, a gear connecting portion 33 protruding inside the first mounting part 10 is formed on the bottom 25 mounted with the bearing 31 of the second mounting part 20.

In an exemplary embodiment of the present invention, the driving unit 50 is provided to rotate the second mounting part 20 at predetermined angles with respect to the first mounting part 10.

For example, the driving unit 50 rotates the second mounting part 20 at predetermined angles and changes the mounting flange of the spot welding gun 2 from the top mounting position to the side mounting position, or from the side mounting position to the top mounting position.

Further, the driving unit 50 can rotate the second mounting part 20 at 180 degrees and change the mounting side of the second mounting part 20 to the position perpendicular to the mounting side of the first mounting part 10 or to the position facing the mounting side of the first mounting part 10.

The driving unit 50 may be mounted on the first mounting part 10 and connected with the second mounting part 20. The driving unit 50 is fixed to the first mounting part 10 and includes a servo motor 61 supplying torque to the second mounting part 20 and a driving gear 63 engaging the servo motor 61 with the gear connecting portion 33 of the second mounting part 20.

The servo motor 61, a part generating a rotational driving force forward/backward in response to an electric signal from a controller, is fixed to the front or rear side of the first mounting part 10. The servo motor 61 includes a driving shaft 62 rotating forward/backward and a driving gear 63 is fitted on the driving shaft 62.

The driving gear 63 may include a worm gear 65 fixed to the driving shaft 62 of the servo motor 61 in an exemplary embodiment of the present invention. A worm wheel 67 engaged with the worm gear 65 is fitted on the gear connecting portion 33 of the second mounting part 20. The worm wheel 67 may be formed integrally with the gear connecting portion 33 or may be fixed to the gear connecting portion 33.

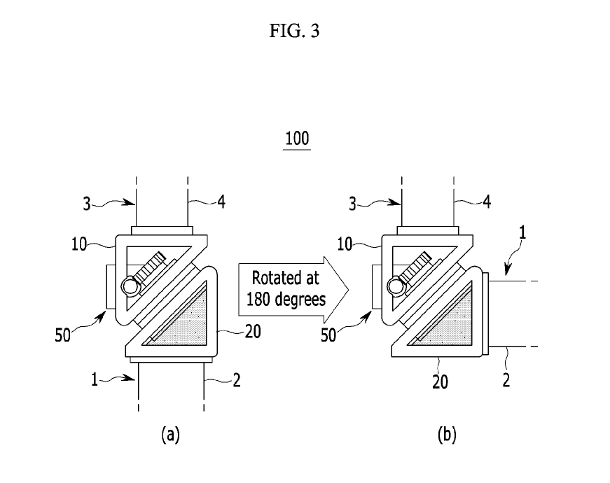

The operation of the mounting position variation apparatus 100 for an assembly device according to an exemplary embodiment of the present invention is described hereafter in detail with reference to FIG. 3.

FIG. 3 is a view illustrating the operation of the mounting position variation apparatus for an assembly device according to an exemplary embodiment of the present invention.

Referring to FIGS. 1, 2, and 3(a), in an exemplary embodiment of the present invention, the mounting side of the first mounting part 10 is connected to the arm end of the welding robot 4, which is the carrying unit 3, through the first mounting bracket 11. Also, the mounting side of the second mounting part 20 is connected to the mounting flange of the spot welding gun 2 that is the assembly device 1.

The mounting side of the second mounting part 20 faces the mounting side of the first mounting part 10 and the mounting flange of the spot welding gun 2 is connected to the mounting side of the second mounting part 20 through the second mounting bracket 21 at the top mounting position.

According to an exemplary embodiment of the present invention, in this state, the spot welding gun 2 is moved to a vehicle body by the welding robot 4, and a part can be spot-welded to the vehicle body by the spot welding gun 2 at the top mounting position of the spot welding gun 2.

On the other hand, in an exemplary embodiment of the present invention, for assembly at the positions of various welding points and for new vehicles or different kinds of vehicle bodies, referring to FIG. 3(b), there is a need to change the position of the mounting flange of the spot welding gun 2 from the top mounting position to the side mounting position.

To this end, in an exemplary embodiment of the present invention, the servo motor 61 is operated in response to a control signal from the controller. Then, the driving shaft 62 of the servo motor 61 rotates in one direction and the worm gear 65 of the driving gear 63 on the driving shaft 62 rotates accordingly in one direction.

When the worm gear 65 of the driving gear 63 rotates in one direction, the torque from the worm gear 65 is transmitted to the gear connecting portion 33 of the second mounting part 20 through the worm wheel 67 because the worm gear 65 is in mesh with the worm wheel 67 on the gear connecting portion 33 of the second mounting part 20.

Accordingly, the second mounting part 20 rotates in one direction with respect to the first mounting part 10 by means of the bearing 31. The servo motor 61 can rotate the second mounting part 20 at 180 degrees in response to a control signal from the controller.

Therefore, in an exemplary embodiment of the present invention, it is possible to change the mounting side of the second mounting part 20 to the position where it is perpendicular to the mounting side of the first mounting part 10.

In particular, in an exemplary embodiment of the present invention, it is possible to change the mounting position of the spot welding gun 2 from the top mounting position to the side mounting position by rotating the second mounting part 20 at 180 degrees.

Further, in an exemplary embodiment of the present invention, it is possible to change the mounting position of the spot welding gun 2 from the side mounting position to the top mounting position by rotating the second mount part 20 while moving the spot welding gun 2 to the position of another welding point by means of the welding robot 4 after finishing welding at the side mounting position of the spot welding gun 2.

Therefore, in an exemplary embodiment of the present invention, it is possible to change the mounting position of the spot welding gun 2 from the top mounting position to the side mounting position or from the side mounting position to the top mounting position, move the spot welding gun 2 to a vehicle body by means of the welding robot 4, and attach a part to the vehicle body with the spot welding gun 2 by spot welding.

According to the mounting position variation apparatus 100 for an assembly device of an exemplary embodiment of the present invention, it is possible to automatically change the mounting position and angle of the spot welding gun 2 on the welding robot 4.

Accordingly, in an exemplary embodiment of the present invention, since it is possible to automatically change the mounting position and angle of the spot welding gun 2 on the welding robot 4, it is possible to actively cope with assembly at the positions of various welding points and for new vehicles and different kinds of vehicle bodies even without manufacturing a new spot welding gun 2 that is the assembly device 1 and a new welding robot 4 that is the carrying unit 3.

Therefore, an exemplary embodiment of the present invention, it is possible to reduce the initial investment cost for manufacture a new assembly device 1 and a new carrying unit 3 to change the mounting position and angle of the assembly device 1 in accordance with the positions of various welding points, new vehicles, or different kinds of vehicle bodies.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mounting position variation apparatus for an assembly device for changing a mounting position and an angle of the assembly device on a carrying unit that can move in several axial directions, the apparatus comprising:
a first mounting part mounted on the carrying unit;
a second mounting part rotatably disposed on the first mounting part and mounted on the assembly device; and
a driving unit mounted on the first mounting part and connected with the second mounting part to rotate the second mounting part at predetermined angles.

2. The apparatus of claim 1, wherein the second mounting part is connected with the first mounting part through a bearing.

3. The apparatus of claim 1, wherein the driving unit changes the mounting position of the assembly device from a top mounting position to a side mounting position by rotating the second mounting part.

4. The apparatus of claim 1, wherein the second mounting part has a gear connecting portion protruding toward the first mounting part.

5. The apparatus of claim 4, wherein the driving unit further comprises:
a servo motor fixed to the first mounting part, and
a driving gear connected with the driving shaft of the servo motor and with the gear connecting portion.

6. The apparatus of claim 5, wherein the driving gear is a worm gear, and
a worm wheel is fitted on the gear connecting portion in mesh with the worm gear.

7. The apparatus of claim 1, wherein the first and second mounting parts each have a triangular cross-section.

8. The apparatus of claim 7, wherein the first and second mounting parts each have two inclined planes and a bottom, and
the bottoms of the first and second mounting parts are connected with each other through a bearing.

9. The apparatus of claim 8, wherein any one of the inclined planes of the first mounting part is the mounting side connected with the carrying unit, and
any one of the inclined planes of the second mounting part is the mounting side connected with the assembly device.

10. The apparatus of claim 9, wherein the second mounting part rotates at 180 degrees with respect to the first mounting part, and
the mounting side of the first mounting part and the mounting side of the second mounting part are positioned to be perpendicular to each other.

11. A mounting position variation apparatus for an assembly device for changing a mounting position and an angle of a spot welding gun on an arm of a welding robot that can move in several axial directions, the apparatus comprising:
a first mounting part mounted on the welding robot;
a second mounting pat rotatably disposed on the first mounting part and mounted on the spot welding gun; and
a driving unit mounted on the first mounting part and connected with the second mounting part to rotate the second mounting part at predetermined angles.

12. The apparatus of claim 11, wherein the driving unit changes the mounting position of the spot welding gun from a top mounting position to a side mounting position by rotating the second mounting part.
